(19) United States
(12) Patent Application Publication
(10) Pub. No.: US 2015/0130641 A1
(43) Pub. Date: May 14, 2015

(54) LOW-COST AND LOW-POWER SMART PARKING SYSTEM UTILIZING A WIRELESS MESH NETWORK

(71) Applicant: QUALCOMM Incorporated, San Diego, CA (US)

(72) Inventors: Md Sazzadur RAHMAN, San Diego, CA (US); Richard FARLEY, San Diego, CA (US); Gang DING, San Diego, CA (US); Padmapriya JAGANNATHAN, San Diego, CA (US); Angela KHANNA, San Diego, CA (US)

(21) Appl. No.: 14/539,786

(22) Filed: Nov. 12, 2014

Related U.S. Application Data
(60) Provisional application No. 61/904,404, filed on Nov. 14, 2013.

(51) Int. Cl. G08G 1/14; H04W 84/18

(52) U.S. Cl. CPC G08G 1/141; H04W 84/18
USPC 340/932.2

(57) ABSTRACT

The disclosure generally relates to a low-cost and low-power smart parking system, and in particular, to forming a multi-hop wireless mesh network that can be used to estimate an occupancy map at a parking facility. The mesh network may be formed according to messages that are broadcasted from wireless identity transceivers corresponding to vehicles parked at the parking facility and include unique identifiers assigned to the broadcasting wireless identity transceivers and unique identifiers in any messages that the broadcasting wireless identity transceivers receive, whereby an occupancy map at the parking facility can be estimated according to the formed mesh network and a known physical layout associated with the parking facility. Furthermore, the broadcasted messages can be used to provide various other parking functions (e.g., contacting vehicle owners, directing drivers to available spaces, assisting with locating parked vehicles, etc.).

### CROSS-REFERENCE TO RELATED APPLICATIONS

The present Application for Patent claims the benefit of Provisional Patent Application No. 61/904,404 entitled “LOW-COST AND LOW-POWER INFRASTRUCTURE-LESS WIRELESS MESH NETWORK FOR SMART PARKING SYSTEM,” filed Nov. 14, 2013, and assigned to the assignee hereof and hereby expressly incorporated herein by reference in its entirety.

### TECHNICAL FIELD

Various embodiments described herein generally relate to a smart parking system that may leverage a low-cost and low-power wireless mesh network.

### BACKGROUND

Smart parking systems are sometimes used to help in routing drivers towards an available parking spot in a parking facility in optimal time and thereby save resources (e.g., time, gas, etc.). Existing smart parking systems typically have a central server maintain information relating to current parking availability in an automated fashion and direct any incoming vehicles to free parking spots accordingly (e.g., via a mobile application, digital signs installed in the parking facility, etc.). However, existing techniques used to provide smart parking systems are typically based on computer vision or sensor data, which suffer from various disadvantages and other limitations. For example, smart parking systems that employ the computer vision approach typically have different cameras installed in a parking facility and analyze images collected from the cameras installed in the parking facility to identify available parking spots. On the other hand, sensor-based smart parking systems typically have sensors installed in each parking spot in order to detect whether the spot is currently occupied and notify the central server accordingly.

Among other disadvantages and limitations, smart parking systems that employ mechanisms based on computer vision and/or sensor data tend to be highly infrastructure dependent. In particular, how many cameras and/or sensors need to be installed depends on the infrastructure in the parking facility (e.g., whether the parking facility is single storied or multi-storied, how many parking spots exist in the parking facility, etc.). Moreover, the cameras and/or sensors that are installed to support the smart parking system are often underutilized. For example, a particular parking facility may have many cameras and/or sensors installed therein despite the fact that few vehicles may be using the parking lot at any given time. Furthermore, computer vision and/or sensor-based smart parking systems may not work well in adverse conditions. For example, the cameras installed at the parking facility may be unable to capture images having sufficient quality in bad lighting or bad weather conditions. Similarly, sensors installed at the parking facility may be unable to accurately detect whether a particular parking spot covered in dust, snow, or other material is actually occupied. Further still, the smart parking approaches that rely on cameras and/or sensors alone cannot sufficiently maintain an association between a vehicle owner and the spot where the vehicle was parked. However, knowing such associations may be valuable or otherwise desirable because the parking facility may need to notify the vehicle owner parked in a specific parking spot (e.g., because the vehicle has been honking for a long time, another vehicle collided with the parked vehicle, etc.). Relatedly, such associations may have further value in assisting a vehicle owner to locate a parked vehicle in the event that the vehicle owner forgot the spot where the vehicle was parked.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to one aspect, the various embodiments disclosed herein may provide a smart parking system that may leverage a low-cost and low-power wireless mesh network based on short-range wireless broadcasts that may be transmitted, received, and otherwise relayed among various identity transceivers located within a parking facility. For example, many vehicles have on-board or otherwise built-in Bluetooth technology, which may be leveraged to form a low-power wireless mesh network that may be substantially transparent to any infrastructure associated with the parking facility and have minimal setup costs. Furthermore, to the extent that certain vehicles (e.g., older or inexpensive vehicle models) may not have on-board technology that can transmit and receive short-range wireless broadcasts, the parking facility may supply owners of such vehicles with dongles, tags, or other suitable devices that can transmit and receive short-range wireless broadcasts, whereby the vehicles that otherwise lack on-board technology that can transmit and receive short-range wireless broadcasts may nonetheless join the wireless low power mesh network. Furthermore, in various embodiments, the parking facility may optionally install one or more relay nodes at selected zones within the parking facility, wherein the relay nodes may comprise wireless identity transmitters, proximity broadcast receivers, and/or other suitable identity transceivers that can receive and relay broadcast messages associated with the vehicles. Accordingly, the various vehicles parked within the parking facility and the various relay nodes installed in the parking facility may generally transmit and receive broadcast messages among one another to form the multi-hop wireless mesh network, whereby a server that knows a physical layout associated with the parking facility may receive sighting messages over the wireless mesh network and use the received sighting messages to maintain an occupancy map associated with the parking facility and provide various other smart parking functions.

According to one aspect, a method to provide a smart parking system may comprise receiving a parking map that comprises a physical layout associated with a parking facility, receiving occupancy notifications over a multi-hop wireless mesh network associated with the parking facility, wherein each occupancy notification may comprise at least a unique identifier assigned to a wireless identity transceiver that corresponds to a vehicle and one or more of the occupancy notifications may further comprise one or more unique identifiers assigned to one or more wireless identity transceivers that correspond to one or more neighbor vehicles from which an occupancy notification was received. As such, the method may further comprise estimating an occupancy map associated with the parking facility based on the occupancy notifications received over multi-hop wireless mesh network and the physical layout associated with the parking facility.

According to one aspect, a server configured to provide a smart parking system may comprise a storage device configured to store a parking map that comprises a physical layout associated with the parking facility, a network interface configured to receive one or more occupancy notifications over a multi-hop wireless mesh network associated with the parking facility, wherein the one or more occupancy notifications may each comprise at least a unique identifier assigned to a wireless identity transceiver that corresponds to a vehicle and one or more of the occupancy notifications may further comprise one or more unique identifiers assigned to one or more wireless identity transceivers that correspond to one or more neighbor vehicles from which an occupancy notification was received, and one or more processors configured to estimate an occupancy map associated with the parking facility based on the occupancy notifications received over multi-hop wireless mesh network and the physical layout associated with the parking facility.

According to one aspect, a computer-readable storage medium may have computer-executable instructions recorded thereon, wherein executing the computer-executable instructions on one or more processors may cause the one or more processors to receive a parking map that comprises a physical layout associated with a parking facility, receive occupancy notifications over a multi-hop wireless mesh network associated with the parking facility, wherein each occupancy notification comprises at least a unique identifier assigned to a wireless identity transceiver that corresponds to a vehicle and one or more of the occupancy notifications further comprise unique identifiers assigned to one or more wireless identity transceivers that correspond to one or more neighbor vehicles from which an occupancy notification was received, and wherein executing the computer-executable instructions on the one or more processors may further cause the one or more processors to estimate an occupancy map associated with the parking facility based on the occupancy notifications received over multi-hop wireless mesh network and the physical layout associated with the parking facility.

According to one aspect, a smart parking system may comprise means for receiving one or more occupancy notifications from one or more wireless identity transceivers that each correspond to a vehicle parked at a parking facility, wherein each occupancy notification may comprise a unique identifier assigned to the wireless identity transceiver that broadcasted the occupancy notification, means for forming a multi-hop wireless mesh network associated with the parking facility based on the one or more received occupancy notifications, and means for providing an estimated occupancy map associated with the parking facility based at least in part on the occupancy notifications used to form the wireless mesh network and a physical layout associated with the parking facility.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments disclosed herein and many attendant advantages thereof will be readily obtained as the same becomes better understood by reference to the following detailed description when considered in connection with the accompanying drawings which are presented solely for illustration and not limitation, and in which:

FIGS. 1A-1C illustrate exemplary high-level system architectures in which a wireless mesh network may be utilized to provide a low-cost and low-power smart parking system, according to various aspects.

FIG. 2 illustrates an exemplary method in which vehicles having built-in wireless mesh networking capabilities may support a low-cost and low-power smart parking system utilizing a wireless mesh network, according to various aspects.

FIG. 3 illustrates an exemplary method in which dongles or other devices having built-in wireless mesh networking capabilities may support a low-cost and low-power smart parking system utilizing a wireless mesh network, according to various aspects.

FIG. 4 illustrates an exemplary on-board wireless identity transceiver that may be installed in a vehicle and leveraged to support a low-cost and low-power smart parking system utilizing a wireless mesh network, according to various aspects.

FIG. 5 illustrates an exemplary wireless identity transceiver that may be provided to vehicle owners at a parking facility and used to support a low-cost and low-power smart parking system utilizing a wireless mesh network, according to various aspects.

FIG. 6 illustrates an exemplary identity transceiver that may be installed in a parking facility and used to support a low-cost and low-power smart parking system utilizing a wireless mesh network, according to various aspects.

FIG. 7 illustrates an exemplary server that may utilize a multi-hop wireless mesh network to provide a low-cost and low-power smart parking system, according to various aspects.

### DETAILED DESCRIPTION

Various aspects are disclosed in the following description and related drawings to show specific examples relating to exemplary embodiments. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects disclosed herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

The term “mobile device” used herein may generally refer to any one or all of cellular telephones, smartphones (e.g., iPhone®), web-pads, tablet computers, Internet-enabled cellular telephones, Wi-Fi enabled electronic devices, personal data assistants (PDAs), laptop computers, personal computers, and similar electronic devices equipped with a short-range radio (e.g., a Bluetooth® radio, a Peanut® radio, a Wi-Fi radio, etc.) and a wide area network connection (e.g., an LTE, 3G, 4G, or other wireless wide area network transceiver or wired connection to the Internet).

The term “broadcast message” used herein may generally refer to short-range wireless broadcast signals broadcast from wireless identity transmitters (defined below) that may include identification information (i.e., unique identifiers) associated with the wireless identity transmitters and/or users associated therewith. In certain embodiments, the unique identifiers may comprise revolving tokens or other suitable identifiers that are periodically changed and/or encrypted in a manner known to a server. In various embodiments, broadcast messages may include other identifying information, such as Bluetooth® MAC addresses and nonces or counters, which may also be encrypted. Additionally, broadcast messages may include metadata and other data, which may include characteristics associated with the wireless identity transmitter transmitting the broadcast messages (e.g., a device type), sensor data, and/or commands or other instructions. In various embodiments, broadcast messages may be transmitted via a wireless communication protocol, such as Bluetooth Low Energy, Wi-Fi, Wi-Fi Direct, Zigbee®, Peanut®, and other limited range radio frequency (RF) communication protocols. In various embodiments, due to the high unreliability associated with certain short-range transmission channels, broadcast messages may be single packet transmissions limited to a certain size (e.g., 80 bits, 10 bytes, 20 bytes, etc.). For example, in various embodiments, the payload in a broadcast message may be 80 total bits, including 4 bits that indicate battery status information and 76 bits that indicate a revolving token. In another example, a broadcast message may include 20 bits representing a nonce or counter and 60 bits representing a revolving token generated in a manner known to a server (e.g., based on a unique device identifier using a pseudo-random function or an encryption algorithm). Furthermore, in various embodiments, the transmit power used to transmit the broadcast messages may be appropriately limited (e.g., to avoid collisions with broadcast messages transmitted from neighbor nodes, to ensure that broadcast messages will only be received at immediate neighbor nodes, etc.).

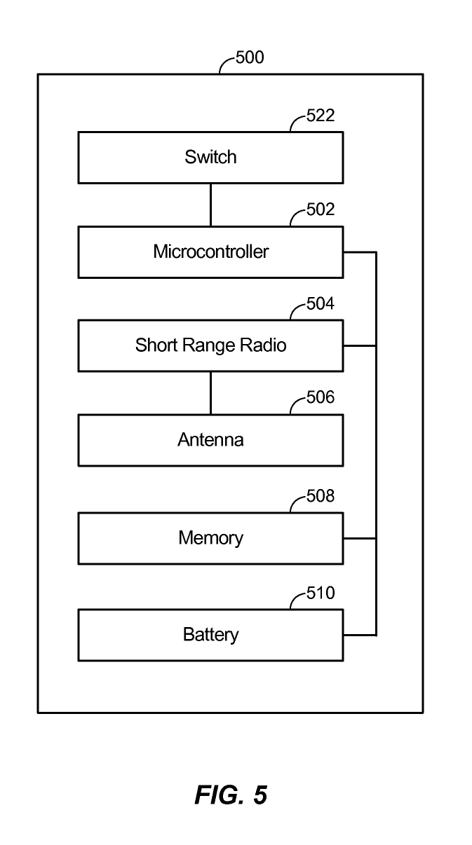

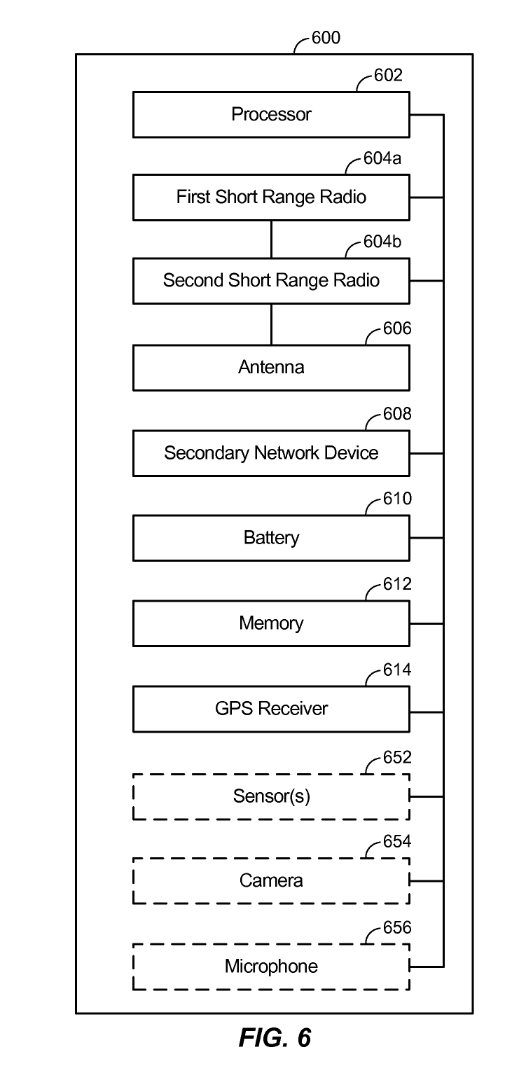

The term “wireless identity transmitter” used herein may generally refer to a compact device configured to periodically transmit broadcast messages via a short-range wireless transmitter. Wireless identity transmitters may be mobile (e.g., when carried or affixed to mobile vehicles, persons, or other items) or may alternatively be stationary (e.g., when installed on fixtures or within buildings). Wireless identity transmitters may store and be associated with a unique device identifier (i.e., a “deviceID”), which may comprise a factory-assigned device identifier. Alternatively (or additionally), the unique device identifier stored in and associated with a wireless identity transmitter may comprise a “revolving token,” which may generally refer to an identifying code unique to the wireless identity transmitter or a user associated therewith and periodically changed (i.e., “revolved”). The revolving token can be created and changed using various encryption and/or encoding techniques and therefore prevent unauthorized devices from tracking a particular wireless identity transmitter. Furthermore, in various embodiments, the unique device identifier, along with other data (e.g., nonce or counter values, device battery state, temperature, etc.), may be encoded, encrypted, or otherwise obfuscated when included within broadcast messages to provide further security. Further still, the wireless identity transmitters may be configured to maintain relatively accurate time (e.g., UTC) information (e.g., by using a 30 ppm 16 kHz crystal oscillator as a clock). Wireless identity transmitters are described throughout the disclosure, in particular with reference to FIGS. 5-6. In various figures and diagrams in this disclosure, a wireless identity transmitter may be referred to as a “WIT” and multiple wireless identity transmitters may be similarly referred to as “WITs.”

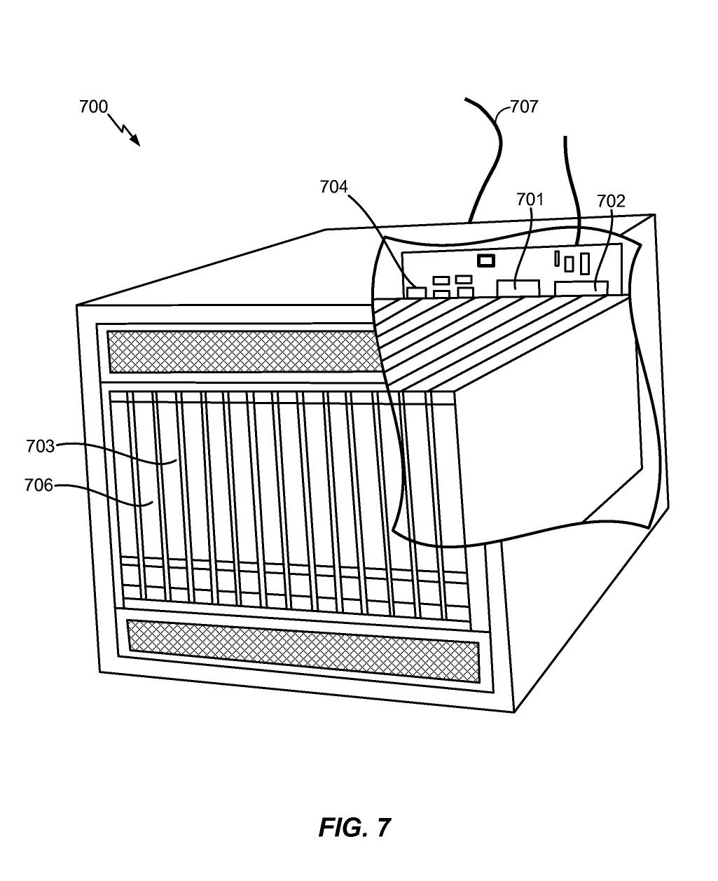

The terms “proximity broadcast receiver” and “mobile proximity broadcast receivers” used herein may generally refer to devices that are configured to receive broadcast messages transmitted from the above-mentioned wireless identity transmitters and to relay the broadcast messages to a server. In various embodiments, proximity broadcast receivers may be stationary devices (or “stationary proximity broadcast receivers”) permanently positioned throughout places (e.g., a parking facility) or mobile devices configured to operate as proximity broadcast receivers (or “stationary proximity broadcast receivers”). For example, a smartphone may be configured to receive broadcast messages and operate as a mobile proximity broadcast receiver. However, unless otherwise indicated, references to proximity broadcast receivers throughout this disclosure are not intended to limit any method or system to a particular proximity broadcast receiver device type (e.g., wireless or stationary). Proximity broadcast receivers are described throughout the disclosure, in particular with reference to FIG. 7. In various figures and diagrams of this disclosure, a proximity broadcast receiver may be referred to as a “PBR” and proximity broadcast receivers may be similarly referred to as “PBRs,” while a mobile proximity broadcast receiver may be referred as an “MPBR” and multiple proximity broadcast receivers may be similarly referred to as “MPBRs.”

The terms “identity transceiver” and “wireless identity transceiver” used herein may generally refer to devices that are configured to receive and transmit broadcast messages. In other words, an identity transceiver may function as both a proximity broadcast receiver and an identity transmitter. For example, in addition to receiving broadcast messages from wireless identity transmitters within proximity, a smartphone may be configured to also broadcast short-range signals using its Bluetooth® transceiver that include its unique identifier and thus also function as a wireless identity transmitter. Throughout this disclosure, various operations may be described as being distinctly performed by either a wireless identity transmitter or a proximity broadcast receiver. However, those skilled in the art will appreciate that a device configured to operate as an identity transceiver may be configured to perform any or all of the same operations, and thus may be interchangeable with references to either a wireless identity transmitter or a proximity broadcast receiver.

The term “sighting message” used herein may generally refer to reports, signals, and/or messages that proximity broadcast receivers send to a server in response to receiving broadcast messages from wireless identity transmitters. Sighting messages may be transmissions that include part or all of the information encoded in received broadcast messages, including any obscured or encrypted information, such as identifiers associated with the broadcasting wireless identity transmitters. Additionally, sighting messages may include metadata and other information (or “associated data”), which may include identification information associated with the sending proximity broadcast receivers (e.g., deviceID, third-party affiliations, etc.), whether the proximity broadcast receiver has been paired with a particular wireless identity transmitter, transmissions context information (e.g., a code indicating that the sighting message relates to an alert or a registered service), information regarding software or applications executing on proximity broadcast receivers (e.g., application identifiers), location information, proximity information with respect to known areas within a place, and timestamp data. In various embodiments, sighting messages may also include authentication information (e.g., secret keys, passes, special codes, digital certificates, etc.) that may a server may use to confirm the identification (or identification information) associated with the proximity broadcast receivers transmitting the sighting messages. For example, a sighting message may include a code from a hash function that can be decoded by the server to ensure the sending proximity broadcast receiver is associated with a particular registered service. In various embodiments, sighting messages may be sent immediately after receiving broadcast messages (e.g., when related to an alert), buffered, or scheduled along with other scheduled transmissions.

The terms “permissions” or “permissions settings” used herein may generally refer to information that indicates whether users of wireless identity transmitters (or transceivers) have authorized providing identities associated therewith to third-parties associated with a server (e.g., a parking facility that provides paid parking services or has registered to receive notifications associated with users that have parked vehicles at the parking facility). Users may set, provide, or otherwise indicate permissions when registering a device (e.g., a wireless identity transmitter) with the server. Permissions may have several values that indicate various privacy levels or authorizations regarding whether disclosing user identification information to third-parties has been authorized. For example, a user may set permissions to indicate that the user is willing to receive notifications or alternatively set permissions to preserve anonymity.

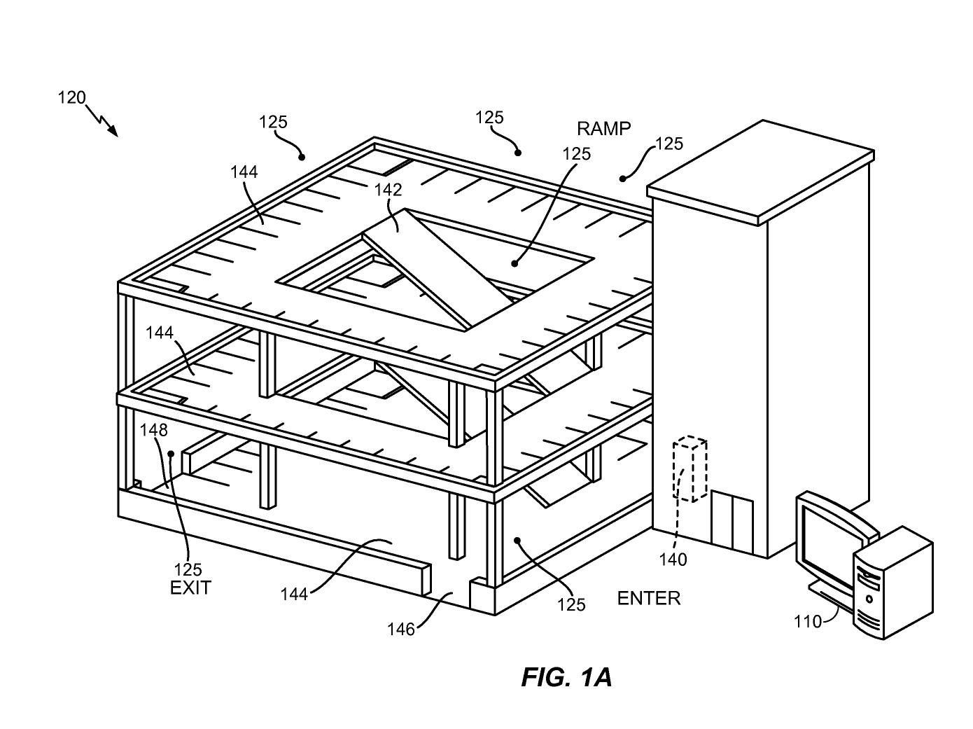

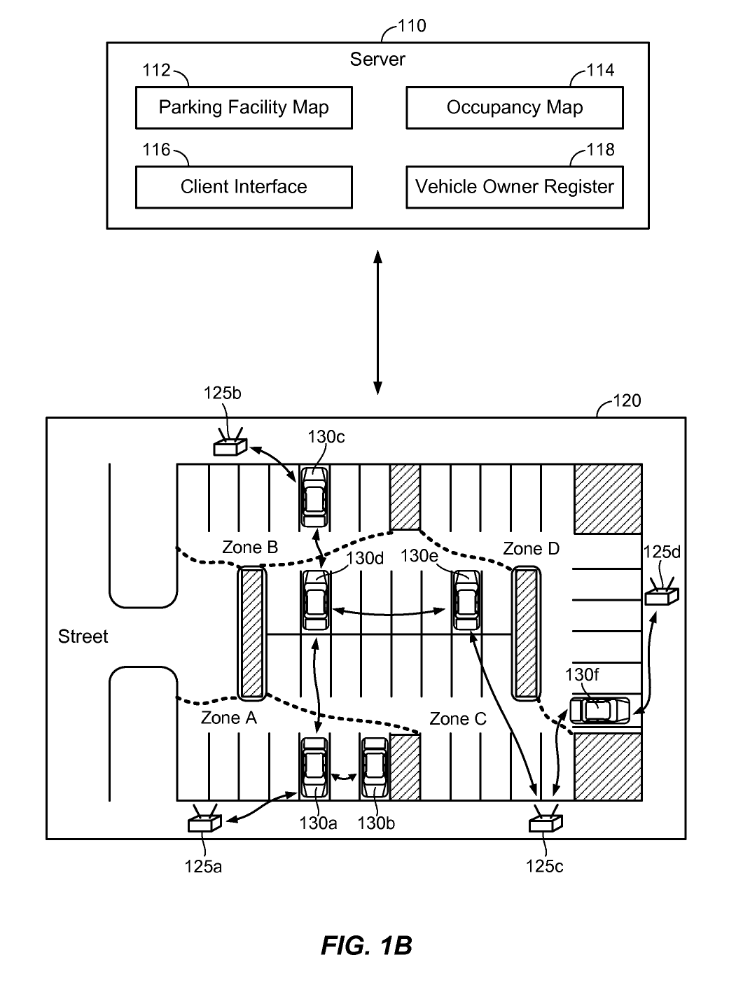

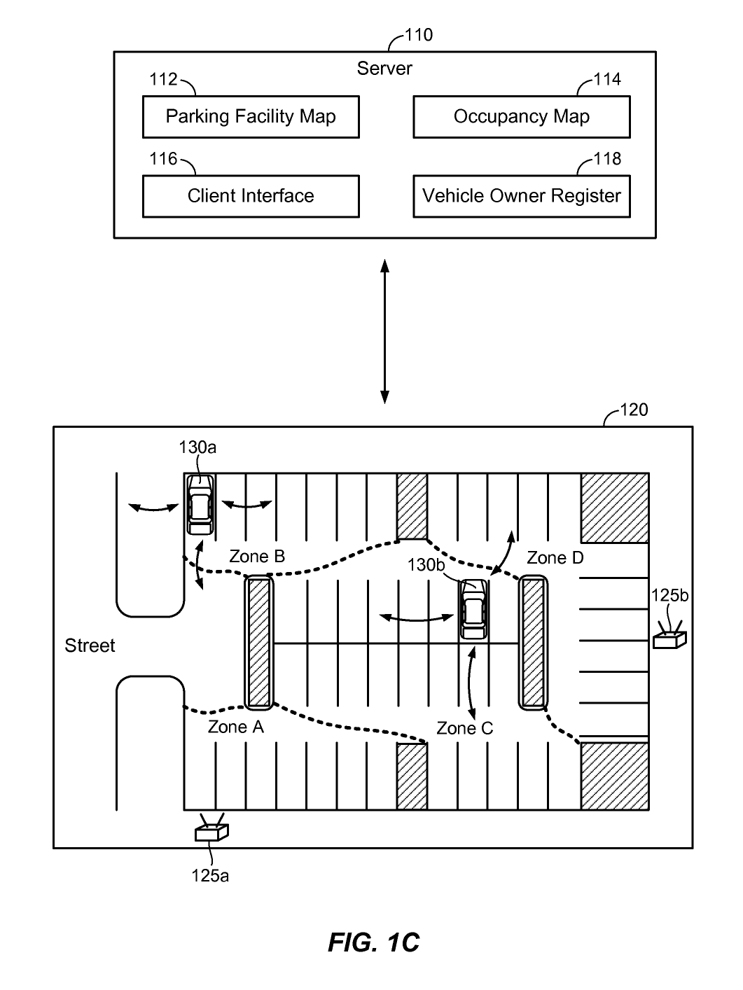

Referring now to FIGS. 1A-1C, the various embodiments disclosed herein may provide a smart parking system that leverages a low-cost and low-power wireless mesh network based on short-range wireless broadcasts that may be transmitted, received, and otherwise relayed among various identity transceivers located within a parking facility 120. In the example shown in FIG. 1, the parking facility 120 may include multiple levels 144, one or more ramps 142 between the various levels 144, an entrance 146 where vehicles enter the parking facility 120, and an exit 148 where vehicles leave the parking facility 120 and any payment that may be required may be collected. Furthermore, in various embodiments, the parking facility 120 may optionally include a payment facility 140 where vehicle owners may pre-pay any parking fees that may be due and receive a ticket that allows the vehicle to leave the parking facility 120 without having to provide payment at the exit 148. Further still, in various embodiments, the parking facility 120 may optionally install a payment collection device that supports direct device-to-device (D2D) communication using a proximity-based peer-to-peer (P2P) protocol at the exit 148, whereby contactless payment may be collected at the exit 148 from any vehicles equipped with technology that support the proximity-based P2P protocol or vehicle owners that have devices that support the proximity-based P2P protocol through D2D communication with the payment collection device at the exit 148 without having to use a transponder or other similar device conventionally used to support contactless payment. For example, in various embodiments, the proximity-based P2P protocol used to support the contactless payment may be based on the AllJoyn™ software framework, which enables interoperability among connected products and software applications from different manufacturers to dynamically create proximal networks and facilitate proximal D2D communication.

According to various embodiments, as mentioned above, the architectures shown in FIGS. 1A-1C may provide a smart parking system that leverages a low-cost and low-power wireless mesh network based on short-range wireless broadcasts that may be transmitted, received, and otherwise relayed among various identity transceivers located within a parking facility 120. For example, many vehicles have on-board or otherwise built-in Bluetooth technology (e.g., Bluetooth Low Energy (BTLE) technology), which has experienced substantial momentum in recent years especially in vehicular contexts to support hands-free calling, music streaming, navigation, and various other applications. As such, in various embodiments, the smart parking systems shown in FIGS. 1A-1C may leverage on-board or otherwise built-in Bluetooth technology that may be readily available in many vehicles to form an ad hoc low-power wireless mesh network that may be substantially transparent to any infrastructure associated with the parking facility 120 and have minimal setup costs. Furthermore, to the extent that certain vehicles (e.g., older or inexpensive vehicle models) may not have on-board technology that can transmit and receive short-range wireless broadcasts, the parking facility 120 may supply owners of such vehicles with dongles, tags, or other suitable devices that can transmit and receive short-range wireless broadcasts, whereby the vehicles that otherwise lack on-board technology that can transmit and receive short-range wireless broadcasts may nonetheless join the wireless low power mesh network.

Furthermore, in various embodiments, the parking facility 120 may optionally install one or more relay nodes 125 at various locations within the parking facility 120, wherein the relay nodes 125 may generally comprise wireless identity transmitters, proximity broadcast receivers, and/or other suitable identity transceivers that can receive and relay broadcast messages associated with the vehicles (e.g., broadcast messages that the vehicles transmit via on-board identity transceivers, broadcast messages that are transmitted from identity transceivers that the parking facility 120 supplies to vehicle owners, etc.). The vehicles parked within the parking facility 120 and the various relay nodes 125 installed in the parking facility 120 may therefore transmit and receive broadcast messages from one another to form a multi-hop wireless mesh network. Accordingly, a server 110 may receive a parking facility map 112 corresponding to a physical layout of the parking facility 120 (e.g., from an entity that manages or otherwise provides the parking facility 120), wherein the server 110 may further store the received parking facility map 112 in an appropriate storage device and receive sighting messages over the multi-hop wireless mesh network from the vehicles parked at the parking facility 120 and/or any relay nodes 125 installed at the parking facility 120 over a suitable wired and/or wireless network interface. The server 110 may therefore collect data from the sighting messages received over the multi-hop wireless mesh network to maintain an occupancy map 114 associated with the parking facility 120 and provide other smart parking functions.

Accordingly, as will be described in further detail herein, the multi-hop wireless mesh network formed from broadcast messages that are transmitted and received within the parking facility 120 may have a low deployment, taking advantage of the popularity of vehicles having on-board technology that can support short-range communication protocols and the inexpensiveness of devices that can correspond to the relay nodes 125 installed in the parking facility 120 to support short-range communication protocols. Furthermore, the relay nodes 125 may be attached to digital signs located in various zones throughout the parking facility 120 that may provide the latest parking information on each zone or otherwise deployed in strategic locations throughout the parking facility to supplement the wireless mesh network formed from the broadcast messages that are exchanged among the vehicles. More particularly, FIG. 1B illustrates an exemplary parking facility in which the relay nodes 125 are installed at locations in the parking facility 120 that have known physical locations, which may assist the server 110 in estimating the occupancy map 114 based on signal strengths associated with the broadcast messages that various vehicles 130a-130f (collectively referred to herein as vehicles 130) parked at the parking facility 120 transmit, receive, and otherwise relay over the multi-hop wireless mesh network in combination with the known physical locations associated with any relay nodes 125 that may receive and relay the broadcast messages to the server 110.

For example, the parking facility 120 shown in FIG. 1B has multiple zones, which includes Zone A, Zone B, Zone C, and Zone D in the illustrated example, where each respective zone may have a digital sign (not shown) that can display the latest parking information in the respective zone and a relay node 125 attached to the digital sign. In this manner, even if only one or relatively few vehicles 130 are parked in a particular zone, having a relay node 125 deployed in each zone may ensure that broadcast messages transmitted from such vehicles 130 will be received at another identity transceiver (e.g., a relay node 125) and appropriately relayed to the server 110. On the contrary, as shown in FIG. 1C, the wireless mesh network may be fragmented if the parking facility 120 only has a few relay nodes 125a, 125b deployed therein and/or only a few vehicles 130a, 130b parked therein, in which case the server 110 may not receive the full occupancy list, and similar issues may arise where the parking facility 120 does not have any relay nodes 125. However, because there are only a few vehicles 130a, 130b forming the fragmented mesh network, the parking facility 120 will typically have plenty of parking space available as in the example illustrated in FIG. 1C. Accordingly, in various embodiments, the smart parking systems shown in FIGS. 1A-1C are robust against any number of relay nodes 120 that may be deployed in the parking lot (e.g., from zero to many), and moreover, as the number of vehicles 130 parked at the parking facility 120 increases, as in the examples illustrated in FIGS. 1A-1B, the mesh network will grow and connectivity between the mesh network at the parking facility 120 and the server 110 will improve.

According to various embodiments, as noted above, the vehicles 130 that park within the parking facility 120 may each have either an on-board wireless identity transmitter or a wireless identity transmitter supplied by the parking facility. In either case, the wireless identity transmitter associated with a particular vehicle 130 may transmit a short-range wireless broadcast that includes a packet or other suitable message having an identifier in a format that can be received at any other identity transceiver within a suitable range. In particular, because the wireless identity transmitter relies on relatively short-range wireless signaling (e.g., short-range radio signals, BTLE signals, light signals, sound signals, etc.) to transmit broadcast messages that include the identifier associated therewith, only neighboring wireless identity transceivers within proximity of the broadcasting wireless identity transmitter may receive such broadcast messages. For example, as shown in FIG. 1B, a vehicle 130b parked in Zone A may transmit a broadcast message that can only be received at a neighboring vehicle 130a parked in Zone A. Nonetheless, a relay node 125a and vehicle 130d may be within sufficient proximity to vehicle 130a such that relay node 125a, vehicle 130d, and vehicle 130b may receive broadcast messages transmitted from vehicle 130a. Accordingly, even though the broadcast message transmitted from vehicle 130b can only be received at neighboring vehicle 130a, the broadcast message transmitted from vehicle 130b can still be appropriately relayed to the server 110 via other vehicles 130 and relay nodes 125 that can indirectly receive information included the broadcast message from vehicle 130b over the multi-hop wireless mesh network.

Accordingly, in various embodiments, the location associated with a wireless identity transceiver that receives a broadcast message may provide an approximate location corresponding to the wireless identity transmitter that transmitted the broadcast message at the time that the broadcast message was received, and a signal strength associated with the received broadcast message may be used to further approximate the location corresponding to the wireless identity transmitter that transmitted the broadcast message. The broadcast messages transmitted from each wireless identity transmitter may therefore include a unique identifier associated therewith, and any broadcast messages transmitted from identity transceivers that receive a broadcast message from another wireless identity transmitter may further include the unique identifier associated with the neighboring wireless identity transmitter. The server 110 may then collect data from the parking facility 120 over the multi-hop wireless mesh network (e.g., from sighting messages that certain vehicles 130 and/or relay nodes 125 transmit to the server 110, which may include the unique identifiers associated with the transmitting vehicles 130 and/or relay nodes 125 in addition to the unique identifiers that correspond to the neighbors associated with the transmitting vehicles 130 and/or relay nodes 125).

Accordingly, in the exemplary smart parking systems shown in FIGS. 1A-1C, an incoming vehicle 130 equipped with on-board technology that supports BTLE or other suitable short-range communication protocols may enter the parking facility 120 at the entrance 146 and join an existing wireless mesh network formed from other vehicles 130 parked in the parking facility 120. Alternatively, if the incoming vehicle 130 does not have on-board technology that supports a suitable short-range communication protocol, the incoming vehicle 130 may receive a dongle or other suitable identity transceiver that the parking facility 120 supplies at the entrance 146 and thereby similarly join the existing wireless mesh network in the parking facility 120 once the owner of the incoming vehicle 130 pulls a tab or otherwise activates the supplied identity transceiver. However, those skilled in the art will appreciate that there may not be an existing wireless mesh network to join when there are no other parked vehicles in the parking facility 120, in which case the incoming vehicle 130 may instead comprise the first node in the wireless mesh network and subsequent incoming vehicles 130 may then join the existing wireless mesh network that the first incoming vehicle 130 started.

In various embodiments, where the parking facility 120 provides paid parking services, a unique identifier may be assigned to the incoming vehicle 130. For example, if the incoming vehicle 130 has on-board technology that supports short-range broadcast messages, the driver may receive a ticket at the entrance 146, wherein the received ticket may include a quick-response (QR) code, a near-field communication (NFC) tag, or other suitable mechanism to indicate the unique identifier assigned to the incoming vehicle 130. Alternatively, if the incoming vehicle 130 does not have on-board technology that supports short-range broadcast messages, the dongle or other suitable identity transceiver supplied to the owner of the vehicle 130 may include the QR code, NFC tag, or other suitable mechanism that indicates the unique identifier assigned to the incoming vehicle 130. In either case, the owner of the vehicle 130 may use a mobile device (e.g., a smartphone) to scan the QR code, tap the NFC tag, or otherwise obtain the unique identifier assigned to the incoming vehicle 130 from the ticket or the supplied identity transceiver, as the case may be. In a further alternative, where the parking facility 120 installs a payment collection device that supports direct D2D communication at the exit 148, any vehicles 130 equipped with technology that further support direct D2D communication and/or vehicle owners that have devices that support direct D2D communication can communicate with another D2D device installed at the entrance 146 to register a contactless payment method and subsequently provide contactless payment through D2D communication with the payment collection device installed at the exit 148 without having to use a transponder or other similar device conventionally used to support contactless payment. In any case, a website or other suitable application may be opened on the device used to make the payment and the owner may enter contact information and a payment method to associate the unique identifier with the owner.

As such, in various embodiments, the unique identifier associated with the owner may be stored on the server 110 within a vehicle owner register 118 and used to support various smart parking functions. For example, the unique identifier may comprise a one-time identifier associated with a particular ticket or a revolving token associated with a particular dongle. In the latter case, the revolving token may be registered and associated with a particular user until that user exits the parking facility 120 and the user leaves the dongle at the parking facility 120. The token may then be revolved such that the dongle can be supplied to another user that enters the parking facility 120, wherein the dongle can then be registered and associated with the next user in a similar manner. As such, the vehicle owner register 118 may define an association between contact information that corresponds to a user and a Media Access Control (MAC) address associated with an on-board short-range communication module or a facility-supplied dongle MAC address registered to the user, which may enable the parking facility 120 to contact the user in different situations (e.g., to help the user to find a parked vehicle 130 in case the user forgets their parking space, to notify the user when the alarm on the vehicle 130 is on, etc.).

In various embodiments, when an incoming vehicle 130 having on-board technology that supports short-range broadcast messages, the driver may pair the mobile device used to obtain the unique identifier from the ticket with the on-board module that supports short-range broadcast messages (e.g., a BTLE-enabled radio) and the mobile device may then send the unique identifier associated with the ticket to the on-board module. The vehicle 130 may then start to broadcast the unique identifier and/or a MAC address associated therewith and listen to neighboring broadcasts once the vehicle 130 has been parked. Furthermore, in subsequent periodic broadcasts, the vehicle 130 may broadcast the unique identifier and/or MAC addresses included in any broadcast messages received from neighboring vehicles 130 in addition to the unique identifier and/or MAC address associated with the vehicle 130. Otherwise, prior to being parked, the on-board module that supports the short-range broadcast messages may remain in sleep mode to save energy. In a similar respect, when the incoming vehicle 130 lacks on-board technology to support short-range broadcast messages, the driver may pull a tab or otherwise activate a switch on the dongle that the parking facility 120 supplied, and the dongle may then start to broadcast the MAC address or a revolving token associated therewith, start to listen to neighboring broadcasts once the dongle has been activated, and broadcast the MAC address or revolving token associated therewith in addition to information associated with neighboring vehicles 130 in subsequent periodic broadcasts. In various embodiments, each wireless identity transceiver (whether an on-board vehicle module, a supplied dongle, a relay node, or otherwise) may be configured to reduce a transmit power associated therewith in response to determining that substantial broadcast messages are received from neighboring nodes in order to avoid collisions. Furthermore, each wireless identity transceiver may limit the transmit power associated therewith to ensure that only immediate neighbor nodes may receive messages broadcasted therefrom.

As such, in various embodiments, each periodically broadcasted message (or “periodic occupancy notification”) exchanged over the multi-hop wireless mesh network may generally include the unique identifier associated with the broadcasting identity transceiver in addition to the unique identifiers associated with each neighbor node from which a periodic occupancy notification was received. Furthermore, in various embodiments, the periodic occupancy notifications may comprise radio signal strength information. The periodic occupancy notifications may eventually be relayed to the server 110 (e.g., via the relay nodes 125, identity transceivers that are closest to the server 110 or located at edges of the wireless mesh network, etc.), wherein the server 110 may then update the occupancy map 114 based on all periodic occupancy notifications that were received over the multi-hop wireless mesh network. For example, in various embodiments, the server 110 may leverage the neighborhood information and signal strength information included in the received periodic occupancy notifications in addition to knowledge about the physical parking facility map 112 in order to estimate the actual occupancy map 114. In another example, if the server 110 does not receive a periodic occupancy notification from one or more particular vehicles 130 in a current reporting period, the server 110 may assume that those vehicles 130 have left the parking facility 120 and appropriately remove the vehicles 130 from the occupancy map 114. Moreover, additional information from the relay nodes 125 may further help the server 110 to estimate the occupancy map 114 (e.g., based on information that the relay nodes 125 provide about particular zones within the parking facility 120). Accordingly, when the parking facility 120 approaches full occupancy, the multi-hop wireless mesh network will be well-connected, which may help the server 110 to produce a more accurate estimated occupancy map 114. On the other hand, when the parking facility 120 has many empty spaces, as in the example shown in FIG. 1C, some periodic occupancy notifications may not reach the server 110 such that the multi-hop wireless mesh network may become fragmented and accuracy in the estimated occupancy map 114 may decrease (e.g., because the relay nodes 125a, 125b are not within sufficient proximity to receive the occupancy notifications that the vehicles 130a, 130b parked at the parking facility 120 broadcast, the parked vehicle 130a, 130b are also not within sufficient proximity to receive the occupancy notifications that one another broadcast, and there are no other vehicles parked in the parking facility 120 that are within sufficient proximity to receive the occupancy notifications broadcasted from parked vehicles 130a, 130b). Nonetheless, as shown in FIG. 1C, the parking facility 120 may have many available parking spaces, whereby the estimated occupancy map 114 and the corresponding instructions that the server 110 returns to the parking facility 120 may be unnecessary because a driver would be able to easily find an empty parking space without assistance. Accordingly, the smart parking systems shown in FIGS. 1A-1C may tolerate fragmentation in certain use cases and provide robustness against parking facilities 120 that have no relay nodes 125 or only a few relay nodes 125 because the need for parking assistance may be less when there are few parked vehicles and greater when there are many parked vehicles, wherein the multi-hop wireless mesh network will become more connected in the latter case.

In various embodiments, as noted above, the server 110 may return the estimated occupancy map 114 to the parking facility 120 to assist drivers in locating available parking spaces. For example, the latest occupancy map 114 may be maintained at the server 110 and synchronized at the parking facility 120, which may have digital signs posted throughout various zones to provide incoming vehicles 130 directions to available parking spaces according to the latest occupancy map 114 (e.g., how many empty parking spaces are available in each zone, how many vehicles 130 have just entered each zone to compete for the available parking spaces, etc.). In another example, the server 110 may include a client interface 116 that can communicate with a mobile application, which may provide drivers with instructions to the nearest available parking space according to the latest occupancy map 114. In various embodiments, the mobile application may use voice instructions to avoid interruption to driving and further leverage the on-board technology that supports hands free calling, navigation, and other applications based on short-range communication protocols. In yet another example, the on-board technology that supports short-range communication protocols and/or a mobile device that supports short-range communication protocols may listen to all notifications in proximity while driving a vehicle 130 in the parking facility 120, whereby any received notifications may be used to determine whether any available parking spaces may be located nearby and instruct the driver without having to contact the server 110. Furthermore, in various embodiments, the server 110 may be configured to make inferences to update the estimated occupancy map 114 based on the space in which a vehicle 130 eventually parks. For example, if the server 110 directs a particular vehicle 130 to a space that appears to be empty in the estimated occupancy map 114 and the vehicle 130 eventually parks elsewhere, the server 110 may infer that the recommended space is actually occupied or otherwise unavailable (e.g., a vehicle 130 parked in the space may be associated with a malfunctioning or disabled wireless identity transceiver, part of a vehicle 130 in an adjacent space may be located in the otherwise empty space such that there is not enough room to park there, etc.).

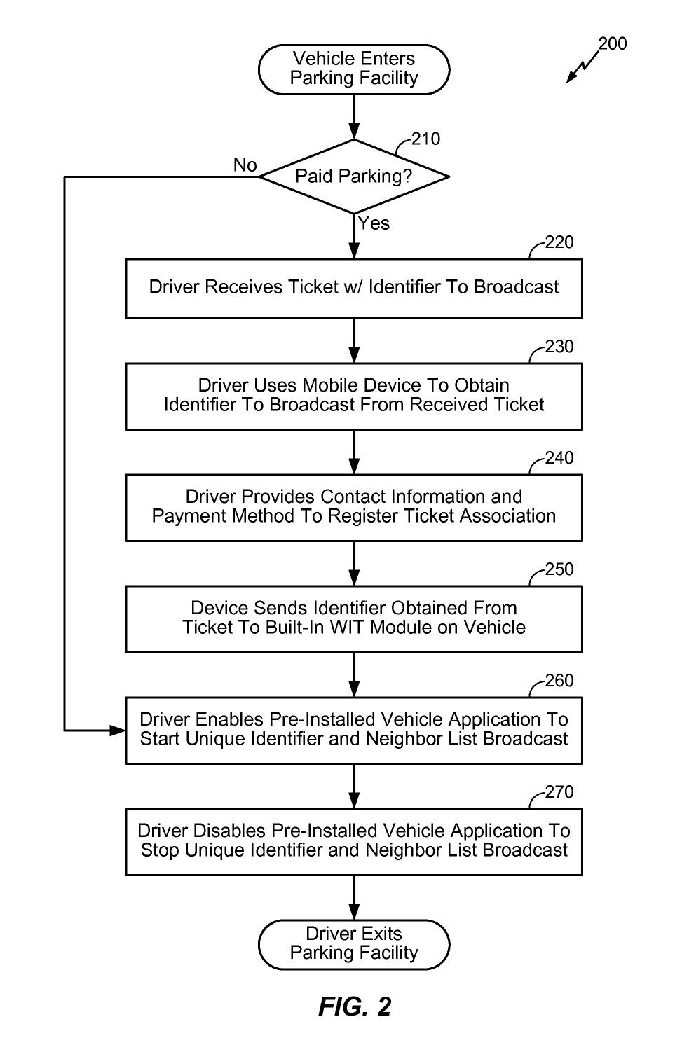

According to various aspects, FIG. 2 illustrates an exemplary method 200 in which vehicles having built-in wireless mesh networking capabilities may support a low-cost and low-power smart parking system. In particular, when an incoming vehicle equipped with on-board technology that supports BTLE or other suitable short-range communication protocols enters a paid parking facility, the driver may receive a ticket upon entering the parking facility at block 220, wherein the received ticket may include a quick-response (QR) code, a near-field communication (NFC) tag, or other suitable mechanism to indicate the unique identifier assigned to the incoming vehicle. Alternatively, if the parking facility provides free parking, the method 200 may branch from block 210 to block 260, which will be described in further detail below. At block 230, the vehicle owner may use a mobile device (e.g., a smartphone) to scan the QR code, tap the NFC tag, or otherwise obtain the unique identifier assigned to the incoming vehicle from the ticket. In response thereto, a website or other suitable application may be opened on the mobile device at block 240, wherein the owner may then enter contact information and a payment method in order to associate the ticket with the vehicle owner. At block 250, the mobile device used to obtain the unique identifier from the ticket may be paired with the on-board module that supports short-range broadcast messages (e.g., a BTLE-enabled radio) and the mobile device may then send the unique identifier associated with the ticket to the on-board module.

In various embodiments, at block 260, the driver may then enable a pre-installed application on the vehicle to start broadcasting its MAC address and neighbor list. As such, at block 260, the vehicle may periodically broadcast an occupancy notification over a multi-hop wireless mesh network, wherein the periodic occupancy notification may generally include a unique identifier associated with the vehicle in addition to unique identifiers associated with each neighbor node from which a periodic occupancy notification was received. Furthermore, in various embodiments, the periodic occupancy notifications may comprise radio signal strength information. The periodic occupancy notifications may eventually be relayed to a server that uses the periodic occupancy notifications to estimate an occupancy map associated with the parking facility based on all periodic occupancy notifications received over the multi-hop wireless mesh network.

In various embodiments, at block 270, the driver may disable the pre-installed vehicle application to stop broadcasting the MAC address and neighbor list prior to exiting the parking facility. As such, the server may subsequently determine that a periodic occupancy notification was not received from the vehicle in a current reporting period and appropriately remove the vehicle from the estimated occupancy map on the assumption that the vehicle left the parking facility.

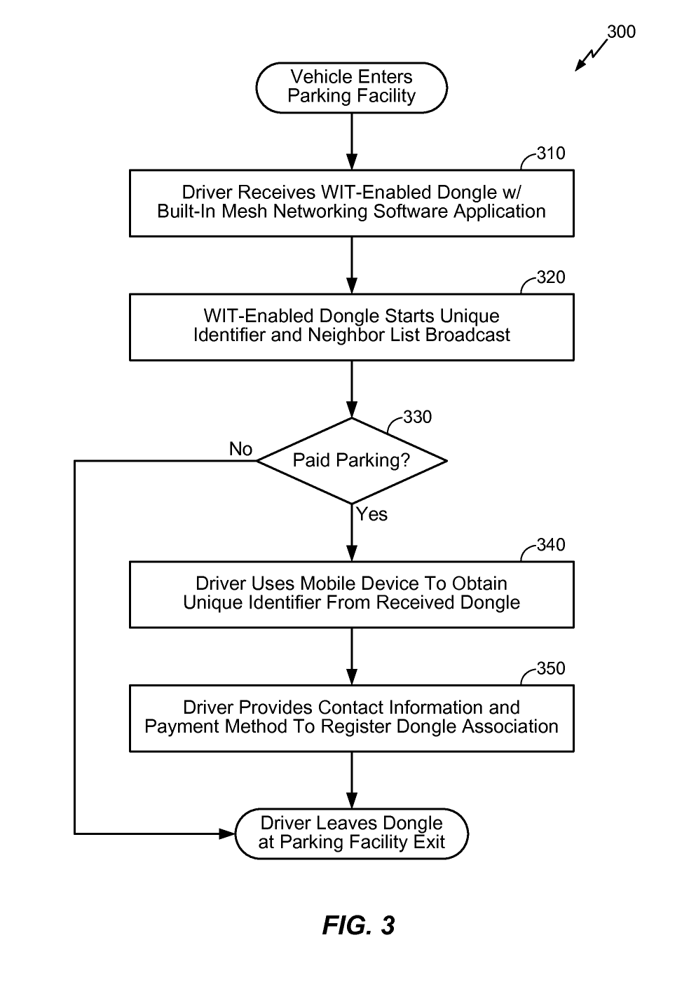

According to various aspects, FIG. 3 illustrates an exemplary method 300 in which dongles or other devices having built-in wireless mesh networking capabilities may support a low-cost and low-power smart parking system. In particular, when an incoming vehicle that does not have on-board technology to support a suitable short-range communication protocol enters a parking facility, the driver may receive a dongle or other suitable identity transceiver from the parking facility at block 310. In response to the vehicle owner pulling a tab or otherwise activating the dongle, the dongle may start broadcasting a MAC address or revolving token associated therewith in addition to a neighbor list associated therewith at block 320. As such, at block 320, the dongle may periodically broadcast an occupancy notification over a multi-hop wireless mesh network, wherein the periodic occupancy notification may generally include a unique identifier (or revolving token) associated with the dongle in addition to unique identifiers associated with each neighbor node from which a periodic occupancy notification was received. Furthermore, in various embodiments, the periodic occupancy notifications may comprise radio signal strength information. The periodic occupancy notifications may eventually be relayed to a server that uses the periodic occupancy notifications to estimate an occupancy map associated with the parking facility based on all periodic occupancy notifications received over the multi-hop wireless mesh network.

In various embodiments, if the parking facility provides paid parking services, the dongle may include a QR code, an NFC tag, or another suitable mechanism to indicate the revolving token associated therewith, in which case the vehicle owner may use a mobile device (e.g., a smartphone) to scan the QR code, tap the NFC tag, or other unique identifier from the dongle at block 340. In response thereto, a website or other suitable application may be opened on the mobile device at block 350, wherein the owner may then enter contact information and a payment method in order to associate the dongle with the vehicle owner. In various embodiments, upon exiting the parking facility, the driver may leave the dongle at the parking facility, whereby the dongle may stop broadcasting and the server may subsequently determine that a periodic occupancy notification was not received from the dongle and appropriately remove the associated vehicle from the estimated occupancy map based on the assumption that the vehicle left the parking facility. Alternatively, if the parking facility provides free parking, the method 300 may branch from block 330 to the final block wherein the driver leaves the dongle at the parking facility such that the server appropriately removes the associated vehicle from the estimated occupancy map.

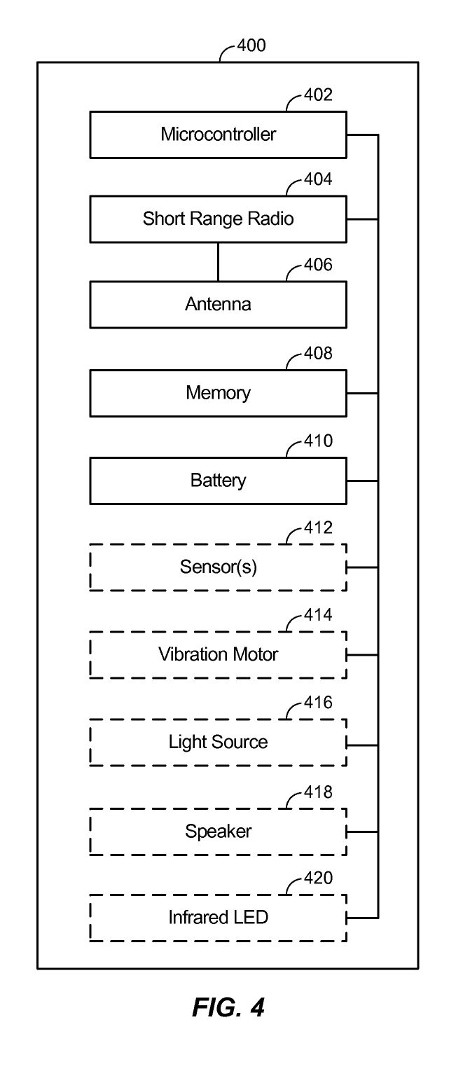

According to various aspects, FIG. 4 illustrates an exemplary on-board wireless identity transceiver 400 that may be installed in a vehicle and used to support a low-cost and low-power smart parking system utilizing a wireless mesh network. In various embodiments, the wireless identity transceiver 400 may include a microcontroller 402, a short-range radio 404 (e.g., a Bluetooth® radio or transceiver) coupled to an antenna 406, a memory 408, and a battery 410. Although FIG. 4 shows the components linked by a common connection, those skilled in the art will appreciate that the various components shown therein may be interconnected and configured in various ways. For example, a wireless identity transceiver 400 may be configured such that the microcontroller 402 may determine when to broadcast a message based on the contents of the memory 408. In various embodiments, the microcontroller 402 may be a Bluetooth system-on-chip unit. The memory 408 may also include one or more messages or message portions that the short-range radio 404 may transmit via the antenna 406 (e.g., based on commands from the microcontroller 402). The battery 410 may supply power as needed by the other components. Furthermore, in certain embodiments, the microcontroller 402, the short-range radio 404, and/or the memory 408 may be integrated within a single integrated circuit. Because the components shown in FIG. 4 may be microchips having a standard or off-the-shelf configuration, the components are generally represented in FIG. 4 as blocks consistent with the structure of an exemplary embodiment.

In various embodiments, as noted above the wireless identity transceiver 400 may be coupled with or built into various objects, such as a vehicle. For example, an exemplary wireless identity transceiver 400 may be included in an on-board radio that implements BTLE technology often used to support hands free calling, music streaming, navigation, and various other vehicular applications. In various embodiments, the wireless identity transceiver 400 may periodically enter a power saving mode or a sleep mode to conserve power. For example, the wireless identity transceiver 400 may remain in sleep mode or otherwise refrain from broadcasting periodic occupancy notifications that include the unique identifier associated therewith until the vehicle has been parked in order to save energy and prevent collisions that may occur while the vehicle owner searches for a parking space. In another example, the wireless identity transceiver 400 may reduce a transmit power associated therewith in response to receiving substantial broadcast messages from other wireless identity transmitters in proximity thereto to avoid collisions with the other broadcast messages. In a further example, the wireless identity transceiver 400 may generally limit the transmit power associated therewith to ensure that the periodic occupancy notifications broadcast therefrom are only received at immediate neighbors that are located within a certain proximity. As such, various embodiments disclosed herein may include different cycles in which the wireless identity transceiver 400 may switch between a broadcast mode, a sleep mode, a reduced transmit power mode, or other suitable states (e.g., waking up periodically to listen for periodic occupancy notifications from neighboring nodes and broadcast a periodic occupancy notification prior to returning to a sleep mode, a listen-only mode, etc.). In various embodiments, the battery 410 may be a replaceable coin cell battery. In another embodiment, the wireless identity transceiver 400 may utilize the antenna 406 to receive update software, instructions, or other data for storage and use in configuration operations, such as configuring transmission intervals and/or transmissions power according to the mechanisms described above.

Additionally, in various embodiments, the wireless identity transceiver 400 may include or be coupled to one or more sensors 412 that can measure various conditions and variables. For example, in various embodiments, the sensors 412 can include an accelerometer, gyroscope, or other suitable motion sensor that can indicate a state of motion associated with the vehicle to the wireless identity transceiver 400. As such, based on the data from the sensors 412, the wireless identity transceiver 400 may detect when the vehicle has entered a parked state and thereby determine when to start broadcasting the periodic occupancy notifications and listening for periodic occupancy notifications broadcasted from neighboring vehicles.

Furthermore, in various embodiments, the wireless identity transceiver 400 may optionally include or be coupled to other components and related circuitry used to broadcast, emit, render, receive, or otherwise process short-range wireless signals. For example, in various embodiments, the wireless identity transceiver 400 may include a vibration motor 414 configured to produce vibration signals that other devices within a certain proximity can detect (e.g., the vibration motor 414 may cause small vibrations to the vehicle that can be detected with sensors that the parking facility may install to estimate the actual occupancy in combination with the data collected over the multi-hop wireless mesh network formed from the short-range wireless broadcasts). In addition, the wireless identity transceiver 400 may include a light source 416 (e.g., a light-emitting diode (LED), a light bulb, etc.) that can produce light signals, a speaker 416 that can produce sound signals, and/or an infrared LED 420 that can produce heat signals. Accordingly, the above-mentioned optional signaling components and related circuitry may be used to generate short-range wireless signals that can be used as alternatives to and/or in combination with the short-range radio signals exchanged with neighboring proximity broadcast receivers. In various embodiments, the wireless identity transceiver 400 may communicate data (e.g., unique identifiers) using the various short-range wireless signal emitters by modulating or encoding the data into emitted signals as described above. For example, the wireless identity transceiver 400 may broadcast a unique identifier by converting data associated therewith into a light signal sequence that a flashing LED periodically emits.

According to various aspects, FIG. 5 illustrates an exemplary wireless identity transceiver 500 that may be provided to vehicle owners at a parking facility and used to support a low-cost and low-power smart parking system utilizing a wireless mesh network. For example, as described in further detail above, the parking facility may supply the wireless identity transceiver 500 to owners of any vehicles that lack built-in technology to support transmitting and receiving low-power short-range broadcast messages in order to allow such vehicles to join or otherwise maintain an existing wireless mesh network within the parking facility. As such, in various embodiments, the wireless identity transceiver 500 shown in FIG. 5 may include a microcontroller 502, a short-range radio 504 (e.g., a Bluetooth® radio or transceiver) coupled to an antenna 506, a memory 508, and a battery 510 similar to the components shown and discussed above with respect to FIG. 5.

However, the wireless identity transceiver 500 shown in FIG. 5 may differ from the wireless identity transceiver 400 shown in FIG. 4 in that the former may store and execute software, algorithms, or other suitable instructions to generate revolving tokens or revolving unique identifiers, as described in further detail above, whereby the wireless identity transceiver 500 may be registered and associated with a particular vehicle owner until that vehicle exits the parking facility and the owner leaves the wireless identity transceiver 500 at the parking facility. The token or unique identifier associated with that wireless identity transceiver 500 may then be revolved such that the same wireless identity transceiver 500 can be supplied to another vehicle owner that enters the parking facility, wherein the wireless identity transceiver 500 may then be registered and associated with the next vehicle owner in a similar manner until that vehicle exits the parking facility and the owner leaves the wireless identity transceiver 500 at the parking facility. Furthermore, if a particular wireless identity transceiver 500 becomes lost or otherwise misplaced, the vehicle owner associated with the most recent revolving token can be identified and appropriately contacted (e.g., to inquire about whether the vehicle owner accidentally forgot to leave the wireless identity transceiver 500 behind when exiting the parking facility). In a similar respect, if a need to contact the vehicle owner currently registered to a particular wireless identity transceiver 500, the vehicle owner can be identified based on the contact information associated with the most recent revolving token and the vehicle owner can therefore be appropriately contacted (e.g., to notify the owner that their vehicle alarm has been set off, another vehicle has collided with their vehicle, to assist the owner in locating their vehicle, etc.).

Furthermore, in various embodiments, the wireless identity transceiver 500 shown in FIG. 5 may further include or be coupled to a switch 512 or other means that can be used to activate the wireless identity transceiver 500 based on a triggering action (e.g., a mercury, mechanical, electrical, magnetic, temperature-sensitive, acceleration-activated, pressure-sensitive, or other switch type). Prior to the triggering action, the wireless identity transceiver 500 may remain off and conserve power. As such, in various embodiments, the switch 512 may generally comprise an activation switch coupled with one or more other components in the wireless identity transceiver 500 (e.g., the microcontroller 502) and configured to activate the wireless identity transceiver 500 in response to some action or event (e.g., in response to a user removing a pullable tab and thereby activating the switch). Once activated, the wireless identity transceiver 500 may begin to broadcast a revolving token or other suitable unique identifier associated therewith in a similar manner to that described in further detail above. Furthermore, the switch 512 may be configured such that the switch 512 can be repositioned (e.g., opened) to deactivate the wireless identity transceiver 500 when the current user exits the parking facility and leaves the wireless identity transceiver 500 behind, whereby the switch 512 may again be activated after the parking facility supplies the wireless identity transceiver 500 to another vehicle owner who subsequently activates the switch 512 in a similar manner to that described above.

As mentioned above, the switch 512 may be any of various switches that may respond to various different triggering events. For example, the switch 512 may comprise a mercury switch that may close in response to moving or tilting the wireless identity transceiver 500 in a particular way, a magnetic switch that may be activated based on a magnetic field applied to the wireless identity transceiver 500 (e.g., when an electric motor is stopped, which may indicate that a vehicle has entered a parked state), a mechanical switch that may be activated in response to acceleration or physical movement (e.g., a pull tab), an accelerometer-activated switch configured to activate when the wireless identity transceiver 500 stops moving for a certain time period that may indicate that a vehicle has been parked, or any other suitable switch that can response to one or more appropriate triggering events. In any case, when activated by the switch 512, the wireless identity transceiver 500 may begin to listen for broadcasted signals that include unique identifiers associated with neighboring vehicles and broadcast a signal that includes a unique identifier associated therewith (e.g., a current revolving token) in addition to the unique identifiers associated with any broadcasted signals received from neighboring vehicles.

According to various aspects, FIG. 6 illustrates an exemplary identity transceiver 600 (e.g., a relay node) that may be installed in a parking facility and used to support a low-cost and low-power smart parking system utilizing a wireless mesh network. In general, the identity transceiver 600 shown in FIG. 6 may include at least a first short-range radio 604a (e.g., a Bluetooth radio or transceiver) that can transmit and receive short-range wireless broadcasts via an antenna 606. Additionally, the identity transceiver 600 may optionally include a second short-range radio 604b, such as a Peanut® transceiver. For example, the identity transceiver 600 may include a Bluetooth® transceiver as the first short-range radio 604a and a Peanut® transceiver or another suitable short-range transceiver as the second short-range radio 604b in order to support different communication protocols that different vehicles may use to transmit broadcast messages. As such, in various embodiments, the first short-range radio 604a and the second short-range radio 604b may utilize the same antenna 606, processor 602, memory 612, and battery unit 610, while the first short-range radio 604a (e.g., the Bluetooth radio) and/or the second short-range radio 604b (e.g., the Peanut radio) may be used to exchange broadcast messages with identity transceivers equipped with corresponding radios.

Additionally, in various embodiments, the identity transceiver 600 may include a secondary network device 608 that can be dedicated to communicating directly or indirectly with a server via a network, such as the Internet or a cellular network. In some embodiments, the secondary network device 608 may be a cellular or wireless radio or a modem or other wired network device. The identity transceiver 600 may further include a processor 602, a memory 612, and a battery 610 either as a primary power supply or a backup power supply in the case where the identity transceiver 600 may be coupled to utility power. The identity transceiver 600 may include a GPS receiver 614 or other location determining mechanism that can determine a current location to associate with any message received from a wireless identity transmitter. If the identity transceiver 600 is not mobile, the identity transceiver 600 may have a known and constant location, in which case the identity transceiver 600 may not include the GPS receiver 614. Furthermore, although the components are shown in FIG. 6 as linked by a common connection, those skilled in the art will appreciate that the various components associated with the identity transceiver 600 shown therein may interconnected and configured in various ways. Further still, because the components shown in FIG. 6 may be microchips having a standard or off-the-shelf configuration, the components are represented in FIG. 6 as blocks consistent with the structure of an exemplary embodiment.

In various embodiments, the identity transceiver 600 may further include or be coupled to other optional components and related circuitry that can detect, receive, or otherwise process short-range wireless signals. For example, in various embodiments, the identity transceiver 600 may optionally include or be coupled to one or more sensors 652 that may be installed in a parking facility to detect when a vehicle has been parked in a particular parking space (e.g., pressure sensors that can detect a vehicle based on a weight threshold function, infrared sensors that can detect heat emitted from vehicles, etc.), wherein the data obtained from the one or more sensors 652 may be used to estimate the actual occupancy in the parking facility in combination with the broadcast messages that are exchanged over the multi-hop wireless mesh network. In another example, the identity transceiver 600 may optionally include or be coupled to a camera 654 that can detect light signals or otherwise capture images in the parking facility to identify available and occupied parking spaces, which may likewise be used in a computer vision approach that may estimate the actual occupancy in the parking facility in combination with the broadcast messages that are exchanged over the multi-hop wireless mesh network. Alternatively (or additionally), the camera 654 may be configured to capture and recognize other suitable information that can be used to maintain or otherwise manage the parking facility (e.g., license plate numbers, vehicle makes and models, or other suitable information that may be relevant to identifying vehicle owners or detecting certain events or conditions in the parking facility, such as a collision that may require incoming drivers to be re-routed until the collision has cleared from driving paths). In another example, the identity transceiver 600 may optionally include or be coupled to a microphone 656 that can receive sound signals that may be broadcasted from certain wireless identity transmitters. Alternatively (or additionally), the microphone 656 may be configured to capture and distinguish sound signals that correspond to vehicle alarms, sound signals that indicate potential vehicle collisions, or other suitable sound signals that may relate to certain events that may trigger a need to notify vehicle owners.

In various embodiments, the identity transceiver 600 may can be plugged into a common RJ-11 telephone jack, whereby the identity transceiver 600 may be configured to listen for short-range radio broadcasts by wireless identity transmitters associated with parked vehicles and relay the broadcasts to a server, process the information within the signal, or ignore the signal entirely. In general, as noted above, the identity transceiver 600 may be installed in various scenarios and places, such as on digital signs posted in various zones throughout the parking facility to provide the latest parking information in each zone. As such, connecting the identity transceiver 600 to telephone communication wires via a common (e.g., wall-mounted) telephone jack may enable the identity transceiver 600 to relay broadcast messages received from parked vehicles and/or dongles associated with parked vehicles to the server over existing telephone lines and may further enable the identity transceiver 600 to receive power from the telephone lines instead of and/or in addition to from the battery 610. Alternatively (or additionally), the identity transceiver 600 may include a dialup-modem connected to the telephone lines or other physical connector that enables the dialup-modem to connect to telephone wires (e.g., an RJ-11 standard modular connector). In various embodiments, the identity transceiver 600 can alternatively (or additionally) be plugged into an Ethernet jack and have a network interface controller to exchange data with the server over an Ethernet data network (e.g., via Ethernet network wiring). As such, the identity transceiver 600 may similarly receive power over Ethernet network wiring instead of and/or in addition to from the battery 610. For example, the identity transceiver 600 may be primarily powered by the battery 610 and alternatively receive power over the Ethernet network wiring when the battery 610 runs low or becomes drained. In another example, the identity transceiver 600 may recharge the internal battery 610 using power received from the telephone wires, the Ethernet network wiring, a utility power source, or other suitable external power sources.

According to various aspects, FIG. 7 illustrates an exemplary server 700 may leverage a multi-hop wireless mesh network to support a low-cost and low-power smart parking system, whereby the server 700 shown in FIG. 7 may be suitable to implement the various embodiments disclosed herein. In general, the server 700 may be a commercially available server device, which may typically include a processor 701 coupled to volatile memory 702 and a large capacity nonvolatile memory, such as a disk drive 703. The server 700 may further include a floppy disc drive, a compact disc (CD) drive, or a DVD disc drive 706 coupled to the processor 701. The server 700 may further include network access ports 704 coupled to the processor 701 to establish data connections with a network 707 (e.g., a local area network coupled to other broadcast system computers and servers). The processor 701 may be any programmable microprocessor, microcomputer or multiple processor chip or chips that can be configured by software instructions (applications) to perform a variety of functions, including the functions corresponding to the various embodiments disclosed herein. In some contexts, multiple processors 701 may be provided, wherein the multiple processors 701 may comprise one or more processors 701 dedicated to wireless communication functions and one or more processors 701 dedicated to running other applications. Typically, software applications may be stored in the internal memory 702, 703 before the software applications are accessed and loaded into the processor 701. The processor 701 may include internal memory sufficient to store and execute the instructions.

Additional details that relate to certain aspects and embodiments disclosed herein, particularly with respect to aspects and embodiments disclosed herein that relate to short-range broadcast messages that may be relayed to a server to determine locations associated with devices that transmitted the broadcast messages and forming a low-power wireless mesh network based on such short-range broadcast messages, may be described in U.S. patent application Ser. No. 13/233,985, entitled “TRACKING MANAGEMENT SYSTEMS AND METHODS,” filed on Sep. 15, 2011 and U.S. patent application Ser. No. 13/773,379, entitled “PLATFORM FOR WIRELESS IDENTITY TRANSMITTER AND SYSTEM USING SHORT RANGE WIRELESS BROADCAST,” filed on Feb. 21, 2013, both of which are hereby expressly incorporated by reference in their entirety and made part of this disclosure.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows various illustrative aspects and embodiments, it should be noted that various changes and modifications could be made herein without departing from the scope and spirit of the disclosure as defined by the appended claims. The functions, steps and/or actions of the method claims in accordance with the various aspects and embodiments described herein need not be performed in any particular order. Furthermore, although elements may be described above or claimed in the singular, the plural is contemplated unless limitation to the singular is explicitly stated.

What is claimed is:

1. A method to provide a smart parking system, comprising:
receiving a parking map from a parking facility, wherein the received parking map comprises a physical layout associated with the parking facility;
receiving occupancy notifications over a multi-hop wireless mesh network associated with the parking facility, wherein each occupancy notification comprises a unique identifier assigned to a wireless identity transceiver that corresponds to a vehicle and unique identifiers assigned to wireless identity transceivers that correspond to one or more neighbor vehicles from which an occupancy notification was received; and
estimating an occupancy map associated with the parking facility based on the occupancy notifications received over multi-hop wireless mesh network and the physical layout associated with the parking facility.

2. The method recited in claim 1, wherein the occupancy notifications further comprise signal strength information associated with the occupancy notification received from the wireless identity transceivers that correspond to each neighbor vehicle.

3. The method recited in claim 1, wherein the wireless identity transceiver supports a short-range communication protocol and comprises an on-board module on the vehicle.

4. The method recited in claim 3, wherein the on-board module starts to broadcast the unique identifier assigned to the wireless identity transceiver associated with the vehicle and the unique identifiers assigned to the wireless identity transceivers that correspond to the one or more neighbor vehicles in response to the vehicle entering a parked state.

5. The method recited in claim 3, wherein the on-board module listens to occupancy notifications in proximity to the vehicle to identify an available parking space in proximity to the vehicle and to provide directions to the available parking space.

6. The method recited in claim 1, wherein the wireless identity transceiver comprises a device supplied at the parking facility.

7. The method recited in claim 1, wherein the wireless identity transceiver broadcasts the occupancy notification at a transmit power determined from a number of occupancy notifications that are received from the neighbor vehicles such that the broadcasted occupancy notification is only received at the neighbor vehicles.

8. The method recited in claim 1, wherein one or more relay nodes installed at the parking facility receive the occupancy notification from the wireless identity transceiver associated with the vehicle and relay the occupancy notification to a server.

9. The method recited in claim 1, further comprising:
identifying one or more vehicles in the estimated occupancy map that did not have a corresponding unique identifier included among the occupancy notifications received in a current reporting period; and
removing the one or more identified vehicles from the estimated occupancy map.

10. The method recited in claim 1, further comprising:
registering associations between the unique identifiers that correspond to the vehicles parked at the parking facility and owners associated with the parked vehicles; and
using the associations to contact the owners associated with the parked vehicles.

11. The method recited in claim 1, further comprising:
transmitting the estimated occupancy map to one or more of the parking facility or an application associated with an incoming vehicle that enters the parking facility, wherein the transmitted estimated occupancy map is used to direct the incoming vehicle to an available parking space.

12. The method recited in claim 11, further comprising:
inferring that the available parking space is occupied in response to the incoming vehicle parking in a different parking space.

13. The method recited in claim 1, wherein the parking facility uses the unique identifier assigned to the wireless identity transceiver that corresponds to the vehicle to collect payment at an exit from the parking facility.

14. The method recited in claim 13, wherein the parking facility collects the payment over a direct device-to-device (D2D) connection between a device installed at the exit from the parking facility and the wireless identity transceiver that corresponds to the vehicle.

15. A server configured to provide a smart parking system, wherein the server comprises:
a storage device configured to store a parking map, wherein the stored parking map comprises a physical layout associated with the parking facility;
a network interface configured to receive one or more occupancy notifications over a multi-hop wireless mesh network associated with the parking facility, wherein the one or more occupancy notifications each comprise a unique identifier assigned to a wireless identity transceiver that corresponds to a vehicle and one or more unique identifiers assigned to one or more wireless identity transceivers that correspond to one or more neighbor vehicles from which an occupancy notification was received; and
one or more processors configured to estimate an occupancy map associated with the parking facility based on the occupancy notifications received over multi-hop wireless mesh network and the physical layout associated with the parking facility.

16. The server recited in claim 15, wherein the one or more occupancy notifications each further comprise signal strength information associated with the occupancy notifications received from the wireless identity transceivers that correspond to the one or more neighbor vehicles.

17. The server recited in claim 15, wherein the one or more occupancy notifications comprise messages that are exchanged among wireless identity transceivers located at the parking facility according to a short-range communication protocol.

18. The server recited in claim 17, wherein one or more relay nodes installed at the parking facility are configured to receive the one or more occupancy notifications exchanged among wireless identity transceivers located at the parking facility and relay the one or more received occupancy notifications to the server.

19. The server recited in claim 15, wherein the one or more processors are further configured to:
identify one or more vehicles in the estimated occupancy map that did not have a corresponding unique identifier included among the occupancy notifications received in a current reporting period; and
remove the one or more identified vehicles from the estimated occupancy map.

20. The server recited in claim 15, wherein the one or more processors are further configured to:
register associations between the unique identifiers that correspond to the vehicles parked at the parking facility and owners associated with the parked vehicles; and
use the associations to contact the owners associated with the parked vehicles.

21. The server recited in claim 15, wherein the network interface is further configured to:
transmit the estimated occupancy map to one or more of the parking facility or an application associated with an incoming vehicle that enters the parking facility; and
transmit instructions to direct the incoming vehicle to an available parking space according to the transmitted estimated occupancy map.

22. The server recited in claim 21, wherein the one or more processors are further configured to infer that the available parking space is occupied in response to the incoming vehicle parking in a different parking space.

23. A computer-readable storage medium having computer-executable instructions recorded thereon, wherein executing the computer-executable instructions on one or more processors causes the one or more processors to:
receive a parking map that comprises a physical layout associated with a parking facility;
receive occupancy notifications over a multi-hop wireless mesh network associated with the parking facility, wherein each occupancy notification comprises a unique identifier assigned to a wireless identity transceiver that corresponds to a vehicle and one or more unique identifiers assigned to one or more wireless identity transceivers that correspond to one or more neighbor vehicles from which an occupancy notification was received; and
estimate an occupancy map associated with the parking facility based on the occupancy notifications received over multi-hop wireless mesh network and the physical layout associated with the parking facility.

24. A smart parking system, comprising:
means for receiving one or more occupancy notifications from one or more wireless identity transceivers that each correspond to a vehicle parked at a parking facility, wherein the one or more occupancy notifications each comprise at least a unique identifier assigned to the wireless identity transceiver that broadcasted the occupancy notification;
means for forming a multi-hop wireless mesh network associated with the parking facility based on the one or more received occupancy notifications; and
means for providing an estimated occupancy map associated with the parking facility based at least in part on the one or more occupancy notifications used to form the multi-hop wireless mesh network and a physical layout associated with the parking facility.

25. The smart parking system recited in claim 24, wherein at least one of the received occupancy notifications further comprises:
a neighbor unique identifier that the broadcasting wireless identity transceiver identified in a neighbor occupancy notification received from a wireless identity transceiver that corresponds to a neighbor vehicle in proximity thereto, and
a signal strength at which the broadcasting wireless identity transceiver received the neighbor occupancy notification.

26. The smart parking system recited in claim 24, further comprising:
means for contacting an owner associated with at least one vehicle parked at the parking facility based on an association between the owner and the unique identifier assigned to the wireless identity transceiver that corresponds to the at least one vehicle.

27. The smart parking system recited in claim 24, further comprising:
means for transmitting information associated with the estimated occupancy map to an application associated with an incoming vehicle that enters the parking facility.

28. The smart parking system recited in claim 24, further comprising:
means for transmitting information associated with the estimated occupancy map for display one or more digital signs located at the parking facility.

29. The smart parking system recited in claim 24, further comprising:
means for collecting contactless payment from at least one vehicle at an exit from the parking facility over a direct device-to-device (D2D) connection based at least in part on the unique identifier assigned to the wireless identity transceiver that corresponds to the at least one vehicle.

30. The smart parking system recited in claim 24, further comprising:
means for relaying the one or more occupancy notifications to a server over the multi-hop wireless mesh network, wherein the server is configured to generate the estimated occupancy map based on the one or more relayed occupancy notifications.
